(19) United States
(12) Patent Application Publication
(10) Pub. No.: US 2006/0273012 A1
(43) Pub. Date: Dec. 7, 2006

(54) Column with additional fluid introduction

(75) Inventor: Bernard Dehmer, Rastatt (DE)

Correspondence Address: PAUL D. GREELEY, ESQ.;OHLANDT, GREELEY, RUGGIERO & PERLE, L.L.P., 10th FLOOR, ONE LANDMARK SQUARE, STAMFORD, CT, 06901-2682, US

(73) Assignee: Agilent Technologies, Inc.

(21) Appl. No.: 11/430,726

(22) Filed: May 9, 2006

Related U.S. Application Data
(63) Continuation-in-part of application No. PCT/EP05/50912, filed on Mar. 2, 2005.

(51) Int. Cl. B01D 15/08

(52) U.S. Cl. 210/656; 210/198.2; 210/639

(57) ABSTRACT

A chromatography column which comprises an adsorbent bed, located in a first fluid flow path between a fluid inlet and a fluid outlet, is provided, and which comprises at least one distribution device, extending into the adsorbent bed and being adapted for fluid introduction. Furthermore methods are provided permitting preconditioning of the stationary phase, performing of separation of a mixture of components and trapping of components.

### CROSS-REFERENCED APPLICATIONS

This application is a continuation-in-part of International Patent Application No. PCT/EP05/050912, filed on Mar. 2, 2005.

### 1. FIELD OF THE INVENTION

The present invention relates to a chromatography column.

### 2. DISCUSSION OF THE BACKGROUND ART

One of the most prominent purification methods for organic molecules is chromatography, permitting fractionation of a mixture of proteins whereby its components become separated. To separate components of a mixture, or “sample”, respectively, fractionation is done by liquid chromatography, in particular by high performance liquid chromatography (HPLC). HPLC can be used as well for preparative and analytical applications: In preparative HPLC, the sample is collected after purification, whereas in analytical HPLC the sample components are simply detected and quantified.

Performing HPLC, the components of interest become dissolved in a solvent in order to obtain a liquid phase, which is then forced into and directed through a chromatography column; usually under a high pressure. An eluent stream is utilized in order to transport the liquid mobile phase through the column, wherein the mixture becomes separated due to the differential retention of each single component on the column. Retention is based on the interaction of the solute with the mobile and the stationary phase or, respectively, based on the different affinities of each single component for the stationary phase. PH value and temperature of the interacting components have also an effect on the retention characteristics. Manipulation of both solvents and stationary phases influences the interaction of the solute with mobile and stationary phase, resulting in a high degree of versatility of HPLC.

When HPLC is carried out for preparative purposes, the components can be enriched within the column, thus becoming “trapped” in a trapping column, remaining there either due do interaction with the stationary phase or as precipitation. Before the trapped components become rinsed out of the column or cartridge, desalting and solvent removing steps can be carried out.

One may also wish to focus on fractionation, accordingly HPLC is a separation device, wherein each component of a sample subjected to separation will emerge from the column at distinct bands, thus being separated in time after the mobile phase is passed through the column. The fractions can be directed in a fraction collector.

In order to improve the affinity of a desired component on the column and to increase the loading capacity of the column, thereby allowing a greater quantity of sample to be separated during a chromatography run, the liquid mobile phase containing the sample is diluted. In U.S. Pat. No. 6,790,361 B2 dilution is performed before the mobile phase enters the chromatography column.

### SUMMARY OF THE INVENTION

It is an object of the present invention to provide an improved liquid chromatography.

Embodiments of the present invention provide a liquid chromatography system, in particular an HPLC system, permitting an improved separation and/or trapping of the sample within a chromatography column during the passage of the mobile phase through the column. This is feasible due to a distribution device, which is arranged and placed inside the chromatography column in a way that it distributes any optional liquid in a counterflow direction to the main stream.

Some embodiments of the chromatography column of the present invention being part of the liquid chromatography system may be designed without having an extra encasement. Others may have an encasement that surrounds an adsorbent bed. The encasement has a first port upstream from the adsorbent bed and a second port downstream from the adsorbent bed, thus permitting a mobile phase to enter the column via the first port, which is the “main stream port”, then to flow from the one end to the other end of the adsorbent bed and leave the column via the second port. Depending on the operating mode, reverse flowing can be arranged. Downstream of the “main stream port” a distribution device is placed, which extends inwards the column encasement into the adsorbent bed. When the solvent delivery unit being connected to the distribution device is operated, fluid flows under pressure counterflow wise into the column, thus providing good mixing of the diluting agent and the sample within the dilution area.

One embodiment refers to the counterflow column of the present invention having a long-bodied distribution device which extends from the bottom end of the column through the adsorbent bed up to the upper retaining layer, adapted to provide a counterflow wise fluid flow. The embodiment allows operating the column in different operating modes, thus permitting the performance of the below exemplary methods such as trapping or separating of molecules such as proteins, e.g.

Herein, the molecules become solved in a fluid, thus a mobile phase is obtained. The mobile phase is directed from the top to the bottom of the column, passing the adsorbent bed. In parallel a second fluid stream is pumped via the distribution device into the column, performing a counter flow, providing dilution of the mobile phase within the column. Performing separation by applying this method, the loading capacity of the chromatography column could be enhanced and troublesome blocking inside injection ports, valves, and interconnecting tubing lines due to precipitation caused by dilution could be avoided.

Additionally, trapping of the molecules of interest can be carried out using the counterflow column of the present invention. For trapping, the column is operated the same manner as described above, but the sample containing mobile phase is strongly diluted, thus having become weak. Accordingly the retention time of the components of interest is significantly increased.

Furthermore, conditioning of the column can be performed with the counterflow column of the present invention. To perform conditioning, the conditioning fluid is pumped via the counterflow device into the column wherein the second ports are blocked or bypassed. There are different options to operate the ports in this application.

One embodiment refers to the the counterflow column being equipped with an extremely short distribution device with the fluid distributing end of the distribution device opening directly into the “bottom” end of the counterflow column, being predestined to be used for on column derivative preparation.

In further embodiments, the distribution device extends up to the upper end of the adsorbent bed or even beyond the adsorbent bed. So, it extends from within the adsorbent bed to a lateral boundary thereof or even beyond such boundary. The boundary might also abut on an additional element which might serve as retaining or mixing device. Accordingly, the distribution device might be arranged in between the element and the adsorbent bed.

In a preferred embodiment, a mixing device is provided in order to achieve a good mixing of the mobile phase with the diluting fluid as provided by the distribution device, before the mixture enters the adsorbent bed. The mixing device can be an individual part or being part or integrated into the the distribution device and/or the frit.

In an other preferred embodiment, wherein the distribution device extends up to the upper end or even extends beyond the adsorbent bed, the mixing device is coupled to or part of the fluid outlet of the distribution device and abuts on a frit or retaining device.

Embodiments may comprise one or more of the following features as laid out in the following paragraphs, whereby the features might be combined in any non-limiting order.

A chromatography column comprises an adsorbent bed located in a first fluid flow path between a fluid inlet and a fluid outlet, and a distribution device extending into the adsorbent bed and being adapted for fluid introduction. The fluid inlet receives from a main solvent delivery unit a mobile phase carrying the components of interest, and the distribution device receives a diluting fluid in order to provide dilution of the mobile phase in the adsorbent bed. The chromatography column may have a column encasement having at least one first port and at least one second port adapted for fluid inlet and/or outlet. The adsorbent bed may have an upper and a lower end, and the first port is located upstream from the adsorbent bed, whereas the second port is located downstream from the adsorbent bed.

A first retaining layer may be placed upstream the adsorbent bed and wherein a second retaining layer is placed downstream the adsorbent bed. The column encasement might have a bottom side in which the distribution device is located. The distribution device can be a shaft comprising at least one tube, channel or capillary adapted for fluid introduction and distribution, the distribution device having a port and at least one opening, which opening merges into the adsorbent bed, preferably up to the retaining layer. A plurality of channels or capillaries might be comprised by the shaft, each of which channels or capillaries opening through the shaft into the adsorbent bed. The first port can be connected to a solvent delivery unit or to an upstream apparatus or device, such as in particular another chromatography column.

A first fluid flow path can be provided from the first port via the adsorbent bed to the second port. The port of the distribution device might be connected to a solvent delivery unit. At least one port can be connected to solvent delivery unit and/or to a downstream apparatus or device such as a detector, a collector and/or an inert gas delivery system and/or another chromatography column. The connection can be coupling one of the ports with the downstream apparatus or device or with the upstream apparatus or device, or with the solvent delivery unit is one of: a force closing connection, a form closing connection, a connection according to the needle seat principle, or a connection according to any other suitable mechanism adapted to perform coupling.

A counterflow path might be provided from the port via the distribution device through the adsorbent bed relative to the first flow path. The adsorbent bed can be a stationary phase. The stationary phase can be comprised of a monolithic phase or of an immobile packing material containing particles. The stationary phase can be designed as a cartridge, and the cartridge might be removable.

The encasement can be coupled with a master device of a liquid chromatography system. The master device or the encasement can be provided with an opening mechanism adapted to change the cartridge. The port of the distribution device can be positioned flush with the bottom side or extends outwards the column encasement.

The opening of the distribution device might be provided with a retaining device. The distribution device and the second port might be arranged concentrically. The distribution device and the second port can be configured to provide a concentric twin connection when coupled with at least one downstream apparatus or element. One or more distribution devices and one or more second ports can be arranged in parallel. A fractionating needle might be placed in the first port according to the needle seat principle and wherein the fractionating needle is connected to a valve.

A chromatography system might comprise at least one chromatography column, in particular with a combination of the features as above, wherein the chromatography system is adapted to perform liquid chromatography, in particular under high pressure. At least two of the chromatography columns might be arranged in line. At least one chromatography column might provide separation and at least one chromatography column might provide trapping of molecules of interest which are comprised in the fluid, and the fluid passes the chromatography column might provide separation first and the chromatography column providing trapping second.

For performing liquid chromatography by utilizing a chromatography column, in particular with a combination of the features as above, the following can be executed:
introducing at least one fluid into the chromatography column via the inlet and/or or the distribution device,
directing the fluid along the adsorbent bed along the first fluid flow path, and
exiting the fluid through the outlet.

Further features might be:
introducing the fluid, which is a mobile phase comprising the molecules of interest, into the chromatography column via one of the first or the second ports, thus providing a main stream,
directing the mobile phase through the adsorbent bed, whereby the molecules of interest interact with the adsorbent bed, and
exiting the mobile phase via one of the first or the second ports.

Conditioning of the adsorbent bed or loading of the adsorbent bed for trapping might be provided, by:
introducing the fluid into the chromatography column via the port of the distribution device,
directing the fluid along the adsorbent bed towards the second port,
maintaining the fluid flow until the adsorbent bed is conditioned or loaded, and
exiting the fluid the via the second port.

The fluid introduced for conditioning might be a conditioning fluid. The fluid being introduced for trapping might be a sample containing fluid comprising the molecules of interest.

The main stream might be maintained during conditioning of the adsorbent bed, thus providing online conditioning.

Further features might be:
introducing the fluid into the chromatography column via the second port,
directing the fluid along the adsorbent bed towards the first port,
maintaining the fluid flow until the adsorbent bed is conditioned or loaded, and
exiting the fluid via the port of the distribution device whereby the fluid is a conditioning or sample containing fluid.

The main stream might be blocked or bypassed during conditioning or loading of the adsorbent bed, thus providing counterflow conditioning or counterflow loading.

Further features might be:
blocking the port of the distribution device,
introducing the conditioning fluid into the chromatography column via the second port,
directing the fluid along the adsorbent bed towards the first port,
maintaining the fluid flow until the adsorbent bed is conditioned, and
exiting the fluid via the first port, thus providing counterflow conditioning of the adsorbent bed.

Further features might be:
blocking the ports of the counterflow column,
introducing the fluid into the chromatography column via the port of the distribution device, with the distribution device being designed as a short-bodied version,
directing the fluid along the adsorbent bed towards the first port, thus conditioning or loading the adsorbent bed
maintaining the fluid flow until the adsorbent bed is conditioned or loaded, and
exiting the fluid via the first port, with the fluid being is a conditioning fluid, a fluid for derivative preparation or a sample containing fluid, accordingly conditioning, derivative preparation or trapping of molecules is provided.

Further features might be:
loading the column, e.g. as set out above, in order to enrich the molecules of interest onto the adsorbent bed,
introducing a rinsing fluid via the first port into the chromatography column until it is flooded, the rinsing providing washing and/or desalting and/or drying
exiting the rinsing fluid via the second port while the port is blocked.

Further features might be: injecting rinsing fluid via the port and rinsing out the components via the second port or injecting rinsing fluid via the second port and rinsing out the components via the port, thus providing recovery of the molecules of interest.

Further features might be: operating a solvent delivery unit containing a fluid such as a mobile phase, a conditioning fluid or a rinsing fluid for introduction into the chromatography column. Pressure can be applied when the solvent delivery unit is operated.

Molecules retained by the adsorbent bed can be washed and/or desalted and/or dried, which can be performed by injecting a washing and/or desalting and/or a drying medium via one of the ports whereas the ports not being in use for injection of the washing and/or desalting and/or drying medium are blocked.

### BRIEF DESCRIPTION OF THE DRAWINGS

Other objects and many of the attendant advantages of the embodiments and methods of the present invention will be readily appreciated and become better understood by reference to the following more detailed description of a preferred embodiment in connection with the accompanying drawings. The below described illustrative embodiments will refer to an implementation in a preparative or analytical HPLC-system. Those skilled in the art will appreciate, that the present invention may also be implemented on other types of liquid chromatography systems.

Features that are substantially or functionally equal or similar will be referred to with the same reference signs. The figures show:

FIG. 1a a cross sectional view of a counterflow column having a distribution device in an operating mode for separating of molecules,

FIG. 1b a schematic view of online conditioning,

FIG. 1c a schematic view of a first countertlow conditioning mode,

FIG. 1d a schematic view of a second counterflow conditioning mode,

FIG. 1e a schematic view of a third counterflow conditioning mode,

FIG. 1f a schematic view of a fourth counterflow conditioning mode,

FIG. 1g a schematic view of trapping column processing,

FIG. 1h a cross sectional view of a “column bottom” comprising a short-bodied distribution device penetrating the retaining layer,

FIG. 1i a cross sectional view of a counterflow column having a distribution device abutting to a mixing device,

FIG. 2a a view of the form-closing port connections, comprising screw and nut,

FIG. 2b a cross view of the port connections according to the needle-seat-principle,

FIG. 2c a cross sectional view of an encasement being part of the master device in which the chromatography column is operated,

FIG. 3a a schematic illustration of separation and online trapping,

FIG. 3b a schematic illustration of on-column dilution,

FIG. 3c schematic illustration of on-column derivative preparation.

### DETAILED DESCRIPTION OF THE PREFERRED EMBODIMENT

Before embodiments of the invention are described in detail, it is to be understood that this invention is not limited to the particular component parts of the chromatography column described or to process steps of the methods described as such liquid chromatography columns systems and methods may vary. It is also to be understood, that the terminology used herein is for purposes describing particular embodiments only and it is not intended to be limiting. It must be noted that, as used in the specification and the appended claims, the singular forms of “a”, “an”, and “the” include plural referents until the context clearly dictates otherwise. Thus, for example, the reference to “a port” includes two or more such ports being comprised in the bottom side of a column encasement, “a distribution device” or “the distribution device” may as well include two or more distribution devices where it is reasonably in the sense of the present invention.

In this specification and in the claims which follow, reference will be made to the following terms which shall be defined to have the herewith explained meanings:

A “mobile phase” as it is used in chromatography is a fluid chosen to dissolve the sample or sample solution, respectively and carry it through the stationary phase of the chromatography column. A mobile phase may be termed “strong” in relation to a “weak” mobile phase and vice versa. The “strength” of the mobile phase refers to the elution force of the mobile phase and is used to describe the affinity that sample component will have for either mobile phase or stationary phase. The behaviour of a mobile phase is depending furthermore on the parameters temperature and pH.

The terms “strong mobile phase” and “weak mobile phase” are known in the state of the art.

As used herein, a “strong mobile phase” refers to a mobile phase that has a high elution strength and leads to little or no retention of the sample on the chromatographic adsorbent. Accordingly, a sample dissolved in a “strong mobile phase” passes the chromatography column with little or no retention of the sample on the stationary phase, thus resulting in a shorter elution time.

A “weak mobile phase” refers to a mobile phase that has a low elution strength and results in a rather high retention of the sample on the chromatographic adsorbent relative to a strong mobile phase. A sample dissolved in a “weak” mobile phase will have less affinity for the mobile phase than the stationary phase, resulting in sample components being strongly retained on the stationary phase and thus having longer elution time.

A “stationary phase” is defined as the immobile packing material in the column. Substantially, the packing material serves as adsorbent; accordingly it is termed “adsorbent bed”, too. The stationary phase can be a monolithic material, whose function is based on its porosity, or it can consist of particles of any sizes. Its surface interacts with the molecules of the components. Adsorption kinetics, longitudinal diffusion and other factors determine the passage of a component through the “stationary phase”.

A “retaining layer” is necessary to keep loose material on its place. Sieves, frits, combination of them or layers of monolithic materials may serve as such retaining layers. According to said definition, a sieve, e.g., may serve as retaining layer, being a “retaining device” then.

The present invention relates to a chromatography column being part of a liquid chromatography system. Generally, a typical high performance liquid chromatography system (HPLC-system) comprises a “main solvent delivery unit”, consisting substantially of a pump in order to move the “mobile phase” at a controlled flow rate and composition and an injection device to introduce the sample solution into the flowing mobile phase. Furthermore a tubular column encasement is needed to surround the stationary phase, forming the “chromatography column”, and a detector to register the presence and amount of the sample components in the mobile phase. The detectors signals may be plotted over time, peaks correspond to the presence of each of the pure components of the sample.

Embodiments of the chromatography column of the present invention are additionally equipped with a “distribution device”, which allows directing an additional fluid flow into the column, preferably counterflow wise with respect to said main solvent stream or “main stream”, respectively, which is injected by a main solvent delivery unit. This additional fluid flow can be a dilution reagent or agent being provided by a second solvent delivery unit.

Generally, the distribution device is a tubular distribution device, having a port which is located outside the chromatography column. It comprises at least one inside tube, channel or capillary. The inner channel or the plurality of channels or capillaries open to the top of the outer tube and/or they may open to the long side of the outer tube, they always open towards the adsorbent bed, reaching up to the upper retaining layer. The lengths of the distribution devices are selectable freely: One may design a distribution device ending with the lower end of the adsorbent bed or with the upper end of it or even extending beyond the adsorbent bed.

Mixing of sample and dilution fluid occurs optimally within a relatively thin layer which covers the complete cross sectional area of the column. The counterflow device provides herein an optimal spreading and distributing due to the dynamic behaviour of the fluid exiting the counterflow device outlet.

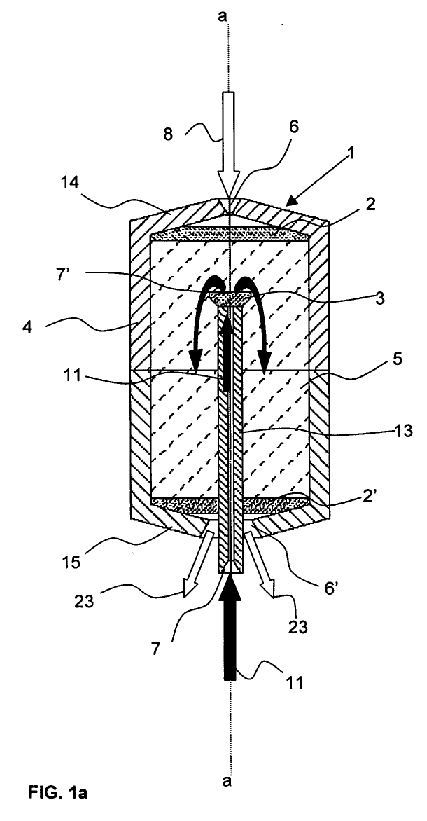

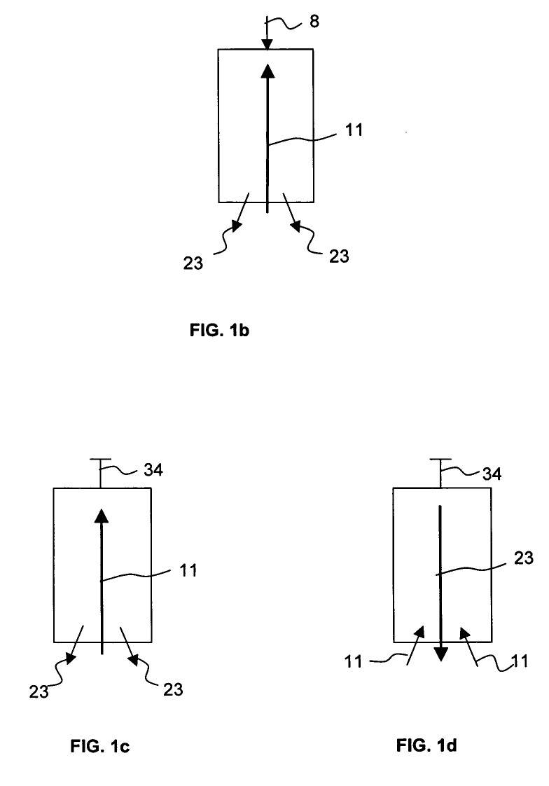

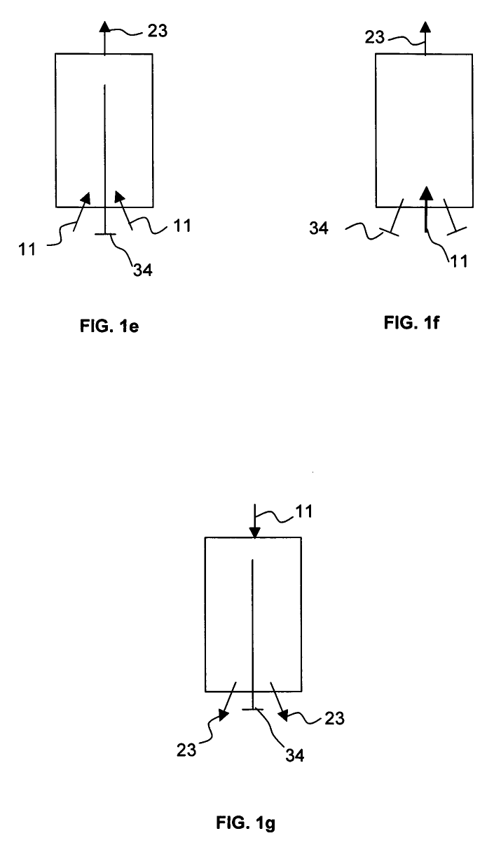

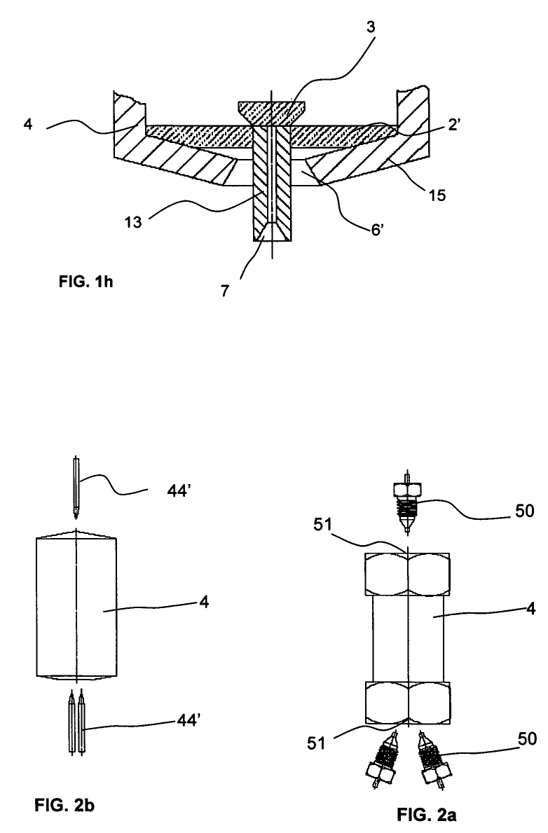

In the following the core of the present invention, which is a chromatography column comprising a distribution device, is figuratively illustrated. FIG. 1a depicts the chromatography column 1 for use in a high performance liquid chromatography system, comprising a column encasement 4 which has a bottom side 15 and a top side 14. The encasement 4 shows a tubular geometry, but any other geometry suitable for use in HPLC could be used.

The encasement 4 contains an adsorbent bed 5 serving as stationary phase, having an upper and a lower end. A stationary phase is generally comprised of a monolithic phase or of a particles containing immobile packing material.

In FIG. 1a, the particles are prevented from being flushed out of the chromatography column 1 by a first frit serving as retaining layer 2, which is placed upstream the adsorbent bed 5, and by a second frit being a retaining layer 2′, which is placed downstream the adsorbent bed 5. A port 6 is provided at the top side 14, and a port 6′ is provided at the bottom side 15 of the encasement 4, accordingly a fluid flow path is provided from the port 6 being located upstream from the adsorbent bed 5, through the adsorbent bed to the port 6′, which is located downstream from the adsorbent bed 5, see the arrow 8, which indicates the main stream, and arrow 23, indicating the flow out.

Said fluid flow path can be reversed, as particularly FIG. 1c shows.

Furthermore, a distribution device 13 is placed in the bottom side 15. One end of the distribution device 13 extends into the encasement 4. It penetrates the retaining layer 2 being located at the bottom end of the adsorbent bed 5 and extends into the same. The other end of the distribution device 13 extends outwards the encasement 4. The tubular distribution device 13 which can be seen in FIG. 1a extends almost to the upper end of the adsorbent bed 5, but it could also be shorter or longer, depending on the method which is mainly intended to be performed with the chromatography column 1.

FIG. 1i shows a chromatography column 1 having a distribution device 13 which extends up to the upper end of the adsorbent bed 5, which adsorbent bed 5 abuts on a lateral boundary which is a mixing device 2″ herein. Said mixing device 2″ provides an optimal mixing of two fluids, one of which entering the chromatography column 1 via the port 6, the other one entering the column via the distribution device 13. Accordingly, one would premix the mobile phase, which carries the components of interest, flowing into the column via port 6, with the diluting fluid as provided by the distribution device 13. Depending on the specific material and design of said mixing device 2″, one may provide a chemical pre-reaction of the fluids or one may just provide a homogenized mixture.

Generally, such a mixing device can be made of materials such as carbon, carbon-fiber materials, porous films, highly porous solids or solid foams. Several other materials may be used in order to provide mixing. Generally, mixing of two fluids and succeeding distribution of the mixture to the adsorbent bed may be performed by using a mixing device which has secondary conduits offering an inner volume to provide the mixing, and primary conduits with dispersion orifices to conduct the mixed fluids into the adsorbent bed.

The distribution device 13, which is shown in FIGS. 1a, 1i and 1h, is designed to permit pumping of a fluid into the chromatography column via the bottom side 15, thus allowing said fluid contacting the adsorbent bed 5 counterflow wise. Accordingly, a second flow path is provided. In order to avoid blocking of the distribution device 13, caused by particles of the adsorbent bed 5 or by precipitation, a retaining layer 2 is comprised, located preferably within the distribution device 13.

Generally, the distribution device of the embodiments of the present invention may extend beyond the adsorbent bed; accordingly it might range from within the adsorbent bed to a lateral boundary thereof and might even extend beyond such boundary. In case the adsorbent bed abuts on a device such as a retaining device or a mixing device or another element, the distribution device might also abut on said device or element.

The mixing device can be an individual component or being part or integrated into the distribution device and/or the element or retaining device, respectively. As an individual component, the mixing device might be arranged in between the element or retaining device and the adsorbent bed.

Being integrated into the distribution device, the opening of the distribution device might merge into the mixing device, so that the fluid passes the mixing device before exiting the distribution device. Being a component of the distribution device, the mixing device might be “sandwiched” in between a retaining layer or frit, e.g., and the adsorbent bed. Being “integrated” or “integrating”, respectively, might be also understood as a coupling of the mixing device to the fluid outlet of the distribution device. Accordingly the mixing device abuts on the frit or retaining device, too, when the distribution device extends up to said frit or retaining device.

In FIG. 1a one can see just one distribution device 13 which is arranged in the center of the concentrically arranged port 6′, the port 6′ being conically tapered from the outside of the encasement 4 to the inside. The distribution device 13 and the port 6′ are configured in this arrangement to provide concentric connections, according to the needle-in-needle-seat-principle e.g.

Generally, the present invention may as well be realized having a plurality of ports serving as inlet- and outlet ports, and it can have a number of distribution devices and ports being arranged in parallel in the bottom 15.

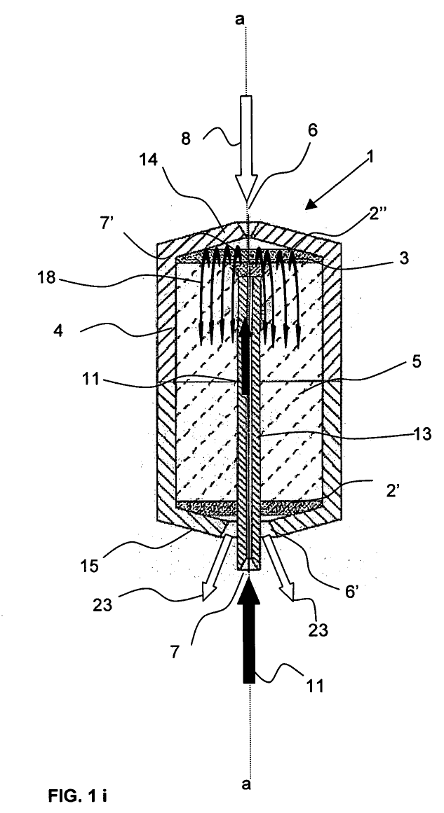

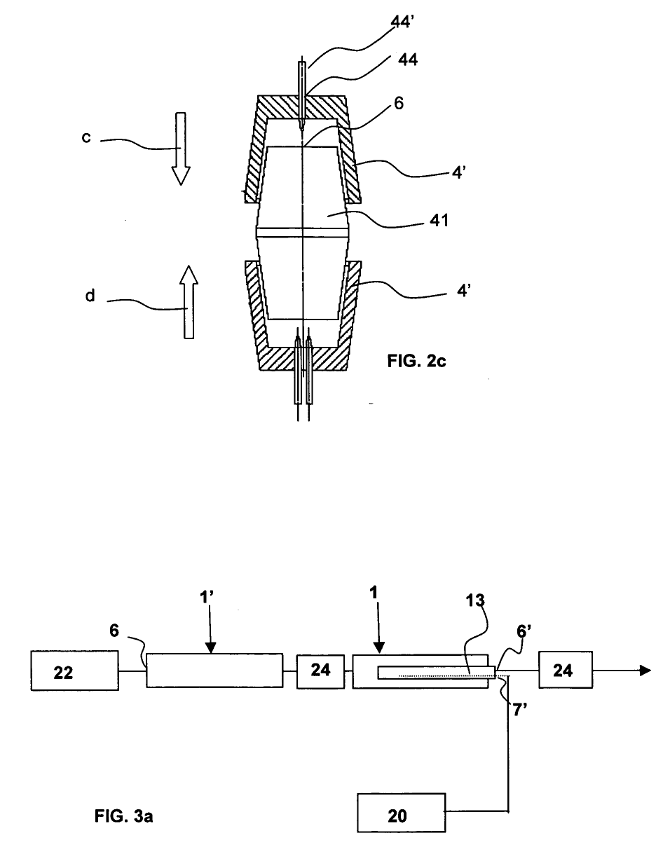

FIG. 2b illustrates the functioning of the device of the present invention, wherein needles 44 are inserted according to the needle-seat-principle into the seat being part of the encasement 4, thus the connection 44 to upstream and downstream apparatuses or devices is designed. Herein, the dual port of the bottom connections is non-concentrically arranged.

In FIG. 2a a device according to the present invention is shown, wherein the connection to upstream apparatuses is based on form closed connecting, the inlet tubes and the outlet tubes having threads 50 for screwing into the nuts 51, being mounted on the encasement 4.

The choice of the connection technique is related with the design of encasement and stationary phase: Generally, columns having packed adsorbent beds need to be additionally sealed by retaining layers such as frits, sieves, or other rigid, porous elements. An adsorbent bed or stationary phase, respectively, can be designed advantageously as a “protected stationary phase” or “cartridge”. The design of inlet port and outlet port connections depends e.g. on the design, consistence and stability of the stationary phase and, accordingly, on how the stationary phase is combined with the encasement.

The chromatography column of the present invention can be realized comprising a high pressure encasement having fixed or form closed connections or comprising a low high pressure housing having force fit connections with a high pressure cartridge inside.

It can furthermore be designed as shown in FIG. 2c: Herein, the low pressure cartridge 41 and encasement 4′ are separated advantageously: The encasement 4′ is designed as a two-pieced hollow device which includes the force fit connections as parts of the instrument. The two-pieced hollow device withstands the high pressure demands. It surrounds the low pressure cartridge 41. Of course, instead of a low pressure cartridge 41 an only protected stationary phase can be used.

The cartridge 41 comprising the stationary phase can be inserted manually or automatically at any time then. Closing of the encasement 4′—herein equipped with connections 44′ to upstream and downstream apparatuses according to the needle-seat principle—can be performed by pushing the two pieces together, as indicated by the arrows c and d. It has to be taken into consideration that a pressure-tight design and a safe closing mechanism have to be chosen.

Advantageously, the cartridges themselves are designed having a definite solidity in order to facilitate the handling after the chromatography method has been performed.

FIG. 1h shows the bottom section of a chromatography column having an extremely short-bodied distribution device 13 having a port 7, said distribution device 13 being placed in the bottom side 15 of the encasement 4 and penetrating a retaining layer 2. The distribution device 13 is concentrically arranged to the ports 6′. This arrangement is very helpful when it is intended to be used as conditioning device, see conditioning according to FIG. 1f, or as on-column derivative preparation device, for example, thus substituting the post-column derivative preparation. Herein, the sample is derived post the separation within one single chromatography column 1.

Of course, in other embodiments of the chromatography column the distribution device can be placed at different portions of the column than at the bottom side. Furthermore it is possible to place more than one distribution device at different portions of the chromatography column.

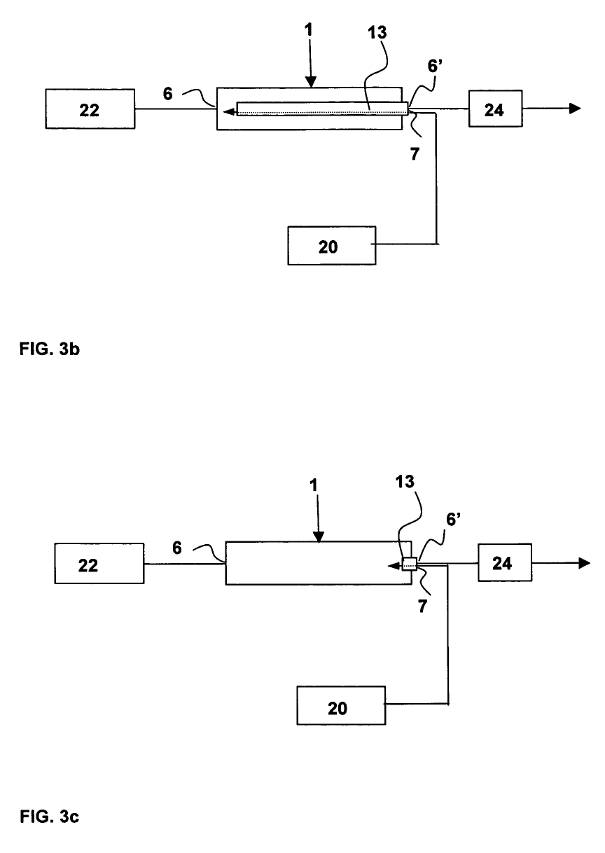

FIGS. 3a, 3b and 3c, which explain the HPLC-system schematically, refer to three chromatography systems comprising chromatography columns 1 having distribution devices 13 which have different lengths. One can see that the length of the distribution device and the positioning may be chosen freely, as long as it corresponds with the method for which it is designed.

The distribution device 13 is connected—via its port 7—to a solvent delivery unit 20. Other options are to connect said port 7 to an extra solvent delivery unit and/or to an inert gas delivery system (not illustrated herein).

The port 6′, which is provided downstream of the chromatography column 1, is connected to the detector 24. The detector 24 is utilized in cases of peak triggered operation: Detecting of the fluid exiting the chromatography column 1′ gives the peaks which indicate when trapping is to be performed. The ports 6′ can furthermore be connected to a fraction collector or inert gas delivery systems. Whereas the port 6, which is the upstream port, is connected to the main solvent delivery unit 22, as schematically shown in FIGS. 3a to 3c. The main solvent delivery unit 22 is adapted for introducing the mobile phase comprising the sample with an appropriate flow rate and composition at the predetermined moment into the chromatography column 1. The connection can by performed by form-closed or force-fit connections. Two suitable options to perform the connections are the ones depicted in FIGS. 2a and 2b.

In case the chromatography system is utilized for trapping (methods see below), as shown in FIG. 3a, a first chromatography column serves as separation column 1′, being connected via its port 6 to the main solvent delivery unit 22 and via its port 6′ to the second detector 24. The fluid which leaves the separation column 1 passes the detector 24 and enters the second chromatography column 1, serving as “trapping column”, via the port 6 of said trapping column. One can do it without the second detector 24, if desired. Furthermore, it has to be taken into consideration that one may wish to have a plurality of trapping columns 1′ in line, with the separation column 1′ generally being connected to the main solvent delivery unit 22. A series of columns can be designed then, advantageously having valves in-between.

Substantially, three methods being related with each other can be performed with the chromatography column of the present invention:

One of them is the preconditioning of the stationary phase of said chromatography column. Generally, stationary phases have to be conditioned before the separation or trapping steps can be carried out. Conventionally, this has to be done by online rinsing of the stationary phase within the pre-run method or in case of post column trapping by performing said steps in an additional preconditioning station.

These extra steps could be performed less time spending or they may even be eliminated by use of a counterflow chromatography column 1 according to the present invention. The preconditioning or online conditioning, respectively, can be understood easily with reference to FIGS. 1b and 1a. To perform preconditioning, the desired preconditioning fluid—such as water e.g.—is injected or pumped via port 7 of the distribution device 13 into the chromatography column 1, see arrow 11, which indicates an inflow, thus causing a fluid flow from the opening 7′ of the distribution device 13 into or through the stationary phase 5 towards the port 6′ (see arrows 23, which indicates an outflow). The fluid flow can be maintained until the desired state of the stationary phase is reached. The preconditioning is performed while the main stream 8 is maintained. Hence, the fluid flow performing pre-conditioning dominates said main stream 8.

FIGS. 1c to 1g (in correlation with FIGS. 1a and 1i) describe schematically the counterflow conditioning. In FIG. 1c, the main stream 8 (not to be seen) is blocked by a plug 34 while the conditioning flow enters via port 7 (see inflow indicated by arrow 11), flows up to the top of the column, floods the column and exits via port 6′ (outflow indicated by arrow 23). The main stream 8 could as well be bypassed.

In FIG. 1d the flow direction is reversed with respect to FIG. 1c, the arrow 11 indicating an inflow and arrow 23 indicating an outflow.

FIG. 1e shows the entering of the conditioning fluid via the port 6′, (inflow indicated by arrow 11) wherein the counterflow device 13 is blocked by use of a plug 34 or any other suitable device. The fluid flow exits via port 6 after having flooded the stationary phase.

In FIG. 1f the utilization of a short-bodied version of the counterflow device is depicted: Herein, the conditioning fluid enters the column via the port 7 (see arrow 11, indicating inflow) while the port 6′ is blocked by a plug 34. After flooding the column the fluid exits via port 6, the outflow indicated by arrow 23. Said short-bodied version is outlined in FIG. 1h. The “column bottom 15” of the encasement 4 shown herein depicts an extraordinary, short distribution device 13 with a retaining device 3, which penetrates the retaining layer 2. The fluid is injected via the port 7 of distribution device 13 into the column.

Another method is the separation or purification of molecules, which can be carried out straight after conditioning, utilizing the same counterflow chromatography column 1 according to the embodiment and the operation mode which is indicated by the arrows 8,11,23, shown in FIG. 1a or by the arrows 8,18,11,23 shown in FIG. 1i.

In order to perform said method of separation or purification, a mobile phase carrying the components of interest is introduced from a main solvent delivery unit 22, which is shown schematically in FIGS. 3a to 3c, via the port 6, into the chromatography column 1, see the arrow 8 in FIG. 1a, which indicates the “main stream”. Referring to FIG. 1a, the mobile phase passes the first retaining layer 2, flows downwards the adsorbent bed 5 or stationary phase, respectively, following the flow path described above. In parallel, introduction of a diluting fluid via the distribution device 13 into the chromatography column is performed; advantageously by means of a device serving as a fluid supply and pumping means, thus providing said additional solvent delivery unit 20, as indicated in FIGS. 3a to 3c. In case a mixing device 2′ is provided, as shown in FIG. 1i, the diluting fluid mixes thoroughly up with the mobile phase within the mixing device before the mixture flows (see arrow 18) into and downwards the adsorbent bed 5.

Usually, introduction will be performed applying a defined flow rate. The diluting fluid is directed now according to a counterflow principle in opposite direction to the sample flow, whereby dilution of the mobile phase takes place where the diluting fluid and the mobile phase start mixing, the mixing being improved due to the counterflow fluidic dynamics. When this occurs, the mobile phase starts being weakened; thus the mobile phase develops from being a “strong mobile phase” to becoming a “weak mobile phase”, accordingly interactions of the components being solved in the mobile phase with the adsorbent bed 5 become enhanced.

It has to be taken into consideration that the position and the flow outlet area influence the partial dilution gradient. The higher the dilution gradient, the higher is the likeliness to obtain precipitation of the sample. It is most advantageous that precipitation can be controlled and can be spread where it occurs. Loss of valuable sample and blocking of valves and other components of the chromatography instrument due to unfavorable upstream precipitation can be reduced or avoided.

Mixing of diluting fluid and mobile phase within the chromatography column may furthermore lead to “viscous fingering” effects, which frequently occur when liquids with different viscosities are injected into a stationary phase. The counterflow the diluting fluid could disturb channels at the very moment of formation. Avoiding viscous fingering means optimizing the loading capacity of the column.

Another method of importance is the trapping of components. Operating the chromatography column in the trapping mode is depicted in FIG. 1b and FIG. 1g: FIG. 1b describes the loading of the column 1 for trapping as outlined above; the loading is performed in analogy to the “online conditioning”. The processing of the chromatography column 1 serving for trapping can be performed according to the mode shown in FIGS. 1c and 1f, or according to FIG. 1g: Herein, the sample is comprised within the column when a rinsing fluid is injected into the column via port 6, (see arrow 11 indicating an inflow) flooding the stationary phase and exiting it via port 6′ while port 7 is blocked. The rinsing fluid may perform washing and/or desalting and drying, the components being trapped in the column can be stored after desalting, removing additives and drying of the components if desired, until they are used for further proceeding.

To recover the desired sample one can rinse out the components by injecting a small volume of rinsing fluid via the inlet 7, taking the fluid and sample from the outlet 6′ then, or vice versa. The components of interest can be taken of the column in order to detect them or in order to subject them to further steps aiming for preparative purposes. Furthermore, time consuming evaporation steps of solvent can be dropped, since most of the solvent has flown out of the column.

By use of the embodiments of the chromatography column and methods of the present invention, precipitation of the sample in injection ports, valves, and interconnecting tubing lines could be avoided completely since the counterflow method dilution takes place within the corpus of the column. Strong dilution of a high sample-concentration containing main stream may cause precipitation of the sample within the stationary phase. But precipitates which are generated within the stationary phase are spread over a wide volume within the stationary phase. Accordingly blocking or significant increasing of the pressure drop within the flow path can be avoided.

What is claimed is:

1. A chromatography column comprising:
an adsorbent bed located in a first fluid flow path between a fluid inlet and a fluid outlet, and
a distribution device extending into the adsorbent bed and being adapted for fluid introduction,
wherein the fluid inlet receives a mobile phase carrying the components of interest, and
the distribution device receives a diluting fluid in order to provide dilution of the mobile phase in the adsorbent bed.

2. The chromatography column of claim 1, wherein said column comprises at least one feature selected from the group consisting of:
the distribution device extends into the adsorbent bed from a location proximate to the fluid outlet; and
the fluid inlet receives the mobile phase from a first solvent delivery unit.

3. The chromatography column of claim 1, wherein said column comprises at least one feature selected from the group consisting of:
the distribution device comprises a shaft having at least one of a tube, channel, and capillary adapted for fluid introduction and distribution, a port, and at least one opening merging into the adsorbent bed;
wherein preferably said shaft comprises a plurality of channels or capillaries, each opening through said shaft into the adsorbent bed; and
the distribution device receives the diluting fluid from a second solvent delivery unit.

4. The chromatography column (1) of claim 1, wherein said column comprises at least one feature selected from the group consisting of:
the distribution device provides a counterflow path of the diluting fluid through the adsorbent bed relative to said first flow path; and
the distribution device extends up to an upper end of the adsorbent bed proximate to the fluid inlet.

5. A chromatography system adapted to perform liquid chromatography, said system comprising:

6. a first column comprising: an adsorbent bed located in a first fluid flow path between a fluid inlet and a fluid outlet, and a distribution device extending into the adsorbent bed and being adapted for fluid introduction, wherein the fluid inlet receives a mobile phase carrying the components of interest, and the distribution device receives a diluting fluid in order to provide dilution of the mobile phase in the adsorbent bed;
a first solvent delivery unit adapted to provide to the fluid inlet of the first column a mobile phase carrying the components of interest; and
a second solvent delivery unit adapted to provide to the distribution device of the first column a diluting fluid in order to provide dilution of the mobile phase in the adsorbent bed of the first column.

7. The chromatography system according to claim 6, further comprising a chromatography column providing separation of the mobile phase, wherein the first column is a trapping column adapted for trapping the components of interest, and the first column is located downstream of the chromatography column.

8. The chromatography system of claim 7, further comprising at least one component selected from the group consisting of: a detector, a collector, and an inert gas delivery system, located downstream of the first column.

9. A method for operating a chromatography column comprising an adsorbent bed located in a first fluid flow path between a fluid inlet and a fluid outlet, and a distribution device extending into the adsorbent bed and being adapted for fluid introduction, the method comprising:
providing a mobile phase stream carrying the components of interest to the fluid inlet, and
providing a diluting fluid to the distribution device in order to provide dilution of the mobile phase in the adsorbent bed.

10. The method according to claim 9, wherein conditioning of the adsorbent bed comprises:
introducing a conditioning fluid into the column via the distribution device or the fluid inlet,
directing said fluid along the adsorbent bed towards the fluid outlet,
maintaining said fluid flow until the adsorbent bed is conditioned or loaded, and
exiting the fluid the via the fluid outlet or the distribution device.

11. The method according to claim 9, wherein
the mobile phase stream is maintained during conditioning of the adsorbent bed, thus providing online conditioning.

12. The method according to claim 9, further comprising blocking or bypassing of said mobile phase stream during conditioning or loading of the adsorbent bed, thus providing counterflow conditioning or counterflow loading.

13. The method according to claim 9, further comprising:
blocking a port of the distribution device,
introducing the conditioning fluid into the chromatography column via a second port,
directing the fluid along the adsorbent bed towards a first port,
maintaining the fluid flow until the adsorbent bed is conditioned,
and exiting the fluid via the first port, thus providing counterflow conditioning of the adsorbent bed.

14. The method according to claim 9, further comprising:
blocking the ports of the counterflow column,
introducing the fluid into the chromatography column via the port of the distribution device, with the distribution device being designed as a short-bodied version,
directing the fluid along the adsorbent bed towards the first port, thus conditioning or loading the adsorbent bed,
maintaining the fluid flow until the adsorbent bed is conditioned or loaded, and
exiting the fluid via the first port, with the fluid being is a conditioning fluid, a fluid for derivative preparation or a sample containing fluid, accordingly conditioning, derivative preparation or trapping of molecules is provided.

15. The method according to claim 9, wherein molecules retained by the adsorbent bed are washed and/or desalted and/or dried.
